(19) United States
(12) Patent Application Publication
(10) Pub. No.: US 2023/0255126 A1
(43) Pub. Date: Aug. 17, 2023

(54) Weed Picking Module and Method

(71) Applicant: Nexus Robotics Inc., St-Bruno-de-Montarville (CA)

(72) Inventor: Jad Tawil, St-Bruno-de-Montarville (CA)

(21) Appl. No.: 17/666,162

(22) Filed: Feb. 7, 2022

(30) Foreign Application Priority Data
Jan. 27, 2022 (CA) 3146854

(51) Int. Cl. A01B 1/16; A01D 34/67; A01B 1/06; A01D 34/81

(52) U.S. Cl. CPC A01B 1/16; A01B 1/065; A01D 34/67; A01D 34/81; A01M 21/02

(57) ABSTRACT

A method and a module for picking weeds or plants with an implement provided on an agricultural vehicle is provided. The method comprises capturing images of a field traveled by the agricultural vehicle, the field comprising weeds and crops. The method also comprises generating a map from the captured images, comprising coordinates of the weeds and crops; determining, based on the coordinates of the weeds and crops, at least one picking location that maximizes a number of weeds to be picked in a single take and one offset for the implement to follow for arriving at the optimal location; moving the implement along the offset; and picking weeds at the optimal location with the implement.

### CROSS-REFERENCE TO RELATED APPLICATIONS

The present application claims benefit of Nexus Robotics Inc., Canadian Patent Application Serial No. ______, filed on Jan. 27, 2022, (Robic, LLP Ref. No. 020662-0008), and entitled “Weed Picking Module and Method.” The entire contents of this application are incorporated herein by reference.

### TECHNICAL FIELD

The technical field generally relates to picking implements for use on agricultural vehicles, and more specifically to modules and methods of optimizing weed or crop picking and removal with automated implements.

### BACKGROUND

Weeds and plants compete with crops for resources, including water, nutrients, and sunlight. Picking of weeds from agricultural fields is a continuous process which improves crop yield by removing competition for resources. Weed picking is a labour-intensive process and there is a desire for automation, such as by use of an autonomous weeding vehicle. A key performance indicator of an autonomous weeding vehicle is its weed picking rate. There is naturally a desire for methods and devices which improve weed picking rates of autonomous weeding vehicles.

### SUMMARY

In accordance with one aspect, there is provided a method for picking weeds with an implement provided on an agricultural vehicle. The method comprises steps to maximize a number of weeds to be picked in a single take. The method may also comprises steps to maximize a number of immature crop to be picked in a single take, to thin the field, i.e. to selectively pick young crop to allow others to grow. The method may comprise steps of capturing images of a field traveled by the agricultural vehicle, the field comprising weeds and crops. The method may comprise a step of generating a map from the captured images, comprising coordinates of the weeds and crops. The method may comprise determining, based on the coordinates of the weeds and crops, at least one picking location that maximizes a number of weeds to be picked in a single take. The method comprises determining one offset for the implement to follow for arriving at the optimal location. The method comprises moving the implement along the offset; and picking weeds at the optimal location with the implement. When the method is used for thinning instead of, or in addition to weeding, the offset is determined based on the location of immature or selected crops to be removed in a single take.

In accordance with one embodiment, the implement avoids contact with the crops as it picks the weeds or selected immature crops.

In accordance with another embodiment, moving the implement comprises a combination of rotational and translational movements.

In accordance with another embodiment, determining the offset comprises first selecting an anchor weed which has to be picked. In other possible implementations, the anchor is an immature or undesired crop that is to be removed to provide more room for other crops.

In accordance with another embodiment, the anchor weed is selected based on proximity to the implement.

In accordance with another embodiment, the anchor weed is selected based on the maximum number of weeds that may be picked in the single take while avoiding contact with the crops.

In accordance with another embodiment, avoiding contact with the crops comprises maintaining a minimum lateral distance between the implement and the crops.

In accordance with another embodiment, determining the offset comprises a step of forming clusters of weeds comprising the anchor weed.

In accordance with another embodiment, the picking location is determined using a first loss function which is optimized by at least one of maximizing the number of weeds to be picked and avoiding the crops within a given space.

In accordance with another embodiment, the offset is determined using a second loss function which is optimized to center the weeds to be picked relative to a center of the implement.

In accordance with another embodiment, inputs to the second loss function comprise the coordinates of the anchor weed, the respective coordinates of additional weeds, and the coordinates of any crops within a footprint of the implement; determining the offset comprises optimizing the second loss function such that the footprint of the implement encompasses the coordinates of the anchor weed and at least one of the coordinates of the additional weeds while excluding the coordinates of any crops; and output of the second loss function comprises the offset to apply to a current position of the implement and an identification of the weeds picked.

In accordance with another embodiment, the step of moving the implement along the offset comprises first applying the offset to a current position of the implement.

In accordance with another embodiment, the offset is further selected from a plurality of potential offsets based on at least one of time and implement travel distance required to pick all weeds at each picking location.

In accordance with another embodiment, the implement is a gripper comprising jaws and wherein the step of picking weeds comprises controlling the jaws of the gripper to pinch stems or roots of the weeds to pick them from the ground.

In accordance with another embodiment, the step of picking weeds comprises adjusting an opening width of the gripper based on the number of weeds to be picked.

In accordance with another embodiment, the images are captured using at least one camera on the agricultural vehicle.

In accordance with another aspect, a weed picking module provided on an agricultural vehicle, the module comprising: an agricultural implement configured and adapted for weed picking, the implement being translatable along three degrees of freedom; a controller configured to control the movement of the agricultural implement; and a processing module comprising: input ports for receiving coordinates of weeds and crops determined from images; and a non-transitory memory and a processor, the non-transitory memory storing the coordinates and instructions for causing the processor to generate an optimal location for the implement that maximizes a number of weeds to be gripped in a single take; and output ports for sending positioning data to the controller, the controller moving the implement in accordance with the optimal location and positioning the implement over the weeds to be gripped based on the positioning data, and controlling operation of the implement to pick the weeds.

In accordance with another embodiment, the implement is also rotatable along at least one degree of freedom.

In accordance with another embodiment, the agricultural implement is a gripper comprising jaws configured and adapted to pinch and retrieve stems or roots of the weeds.

In accordance with another embodiment, one of a delta robot or a gantry system operatively connected to the agricultural implement, for translating the implement along the three axes.

In accordance with another embodiment, the controller comprises at least one first actuator for controlling movement of the gripper and a second actuator for actuation of the gripper.

In accordance with another embodiment, the memory comprises instructions to form clusters of weeds comprising an anchor weed.

In accordance with another embodiment, the memory stores a loss function which is optimized so at to maximize at least one of: number of weeds; and distance of the implement to the crop.

In accordance with another embodiment, the instructions stored in memory cause the processor to: input coordinates of the anchor weed, respective coordinates of additional weeds, coordinates of a crop, and a footprint of the implement to the loss function; optimize the loss function such that the footprint of the implement encompasses the coordinates of the anchor weed and at least one of the coordinates of the additional weeds while excluding the coordinates of the crop; and output, from the loss function, an offset to apply to a current position of the implement and an identification of the weeds picked.

All of the embodiments above can be implemented for field thinning, instead of, or in addition to, weeding.

Other features of advantages of the present invention will be better understood upon reading example embodiments thereof, with reference to the appended drawings. While the invention will be described in conjunction with example embodiments, it will be understood that it is not intended to limit the scope of the invention to such embodiments. On the contrary, it is intended to cover all alternatives, modifications and equivalents as defined in the present application.

### BRIEF DESCRIPTION OF DRAWINGS

FIG. 1 is a perspective view of an example implementation of an autonomous weed picking vehicle having a weed picking module (not shown) mounted underneath;

FIG. 2 is a side-view of a disassembled portion of the body of the vehicle of FIG. 1, along with the weed picking module visible underneath;

FIG. 3 is a top-down view of the body of the vehicle and the weed picking module of FIG. 2 placed side-by-side;

FIG. 4 is a view of an agricultural implement assembly, specifically a gripper assembly, that may be used in accordance with the methods described herein;

FIG. 5 is a close-up view of jaws of the gripper of FIG. 2;

FIG. 6 is an example of a 3D plot of a function representing the gripper footprint, for z≤1, extending between two jaws of the gripper of FIGS. 4 and 5;

FIG. 7 is a representation of a top view of a field in the 2D plane with weeds identified as x-shaped and crops identified as circles, and an anchor weed identified as an x surrounded by a circle;

FIG. 8 is an example of an optimized gripper footprint in accordance with the methods described herein, showing an optimum solution of the field of FIG. 6 for maximum weed picking in a single take while respecting the constraint of not picking crops; and

FIG. 9 is an example flow chart of possible steps carried out to pick in a single take a maximum number of weeds at an optimal location, in accordance with one implementation.

### DETAILED DESCRIPTION

Broadly described, the picking module can be used on or with an agricultural vehicle, such as an autonomous weeding machine, capable of navigating farm fields while identifying weeds and pulling them using a controllable implement, such as a robot gripper. The module focuses on picking and removing weeds or other undesired plant growing close to the crop where other means of weeding are not effective and manual labor is employed. The weeds are picked by physically gripping them and pulling them from the earth and then discarding them on the ground.

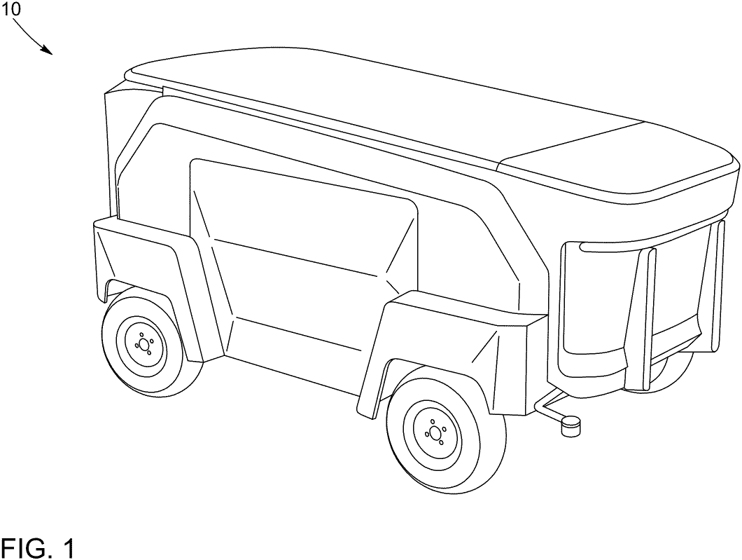

With reference to FIG. 1 and in accordance with one implementation, there is shown an agricultural vehicle 10 for picking weeds or for thinning crops from an agricultural field. The vehicle 10 shown therein is configured to travel along lanes in an agricultural field, over longitudinal sections of soil, to pick, remove and dispose of weeds. In possible implementations, the vehicle is an autonomous vehicle, comprising cameras, sensors and processors to control electric motors and wheels connected to the motor(s). In other possible implementations, the vehicle can a tractor or other agricultural vehicle, controller by a driver. The crops can be of different types, including vegetable crops, such as lettuces, carrots, and onions.

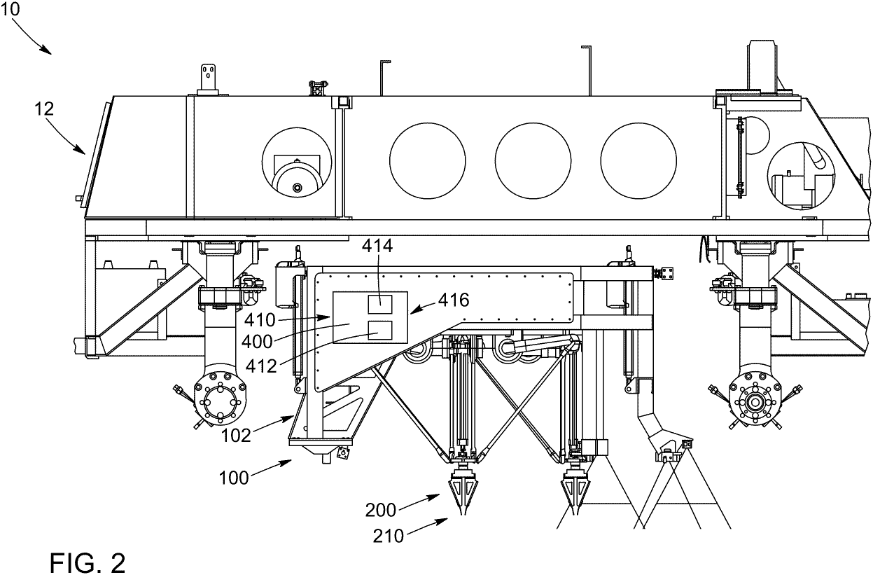

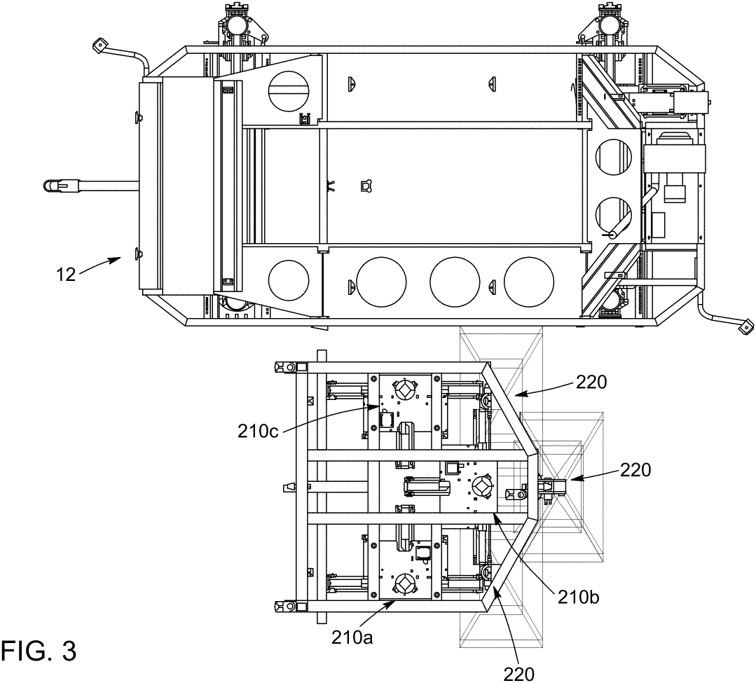

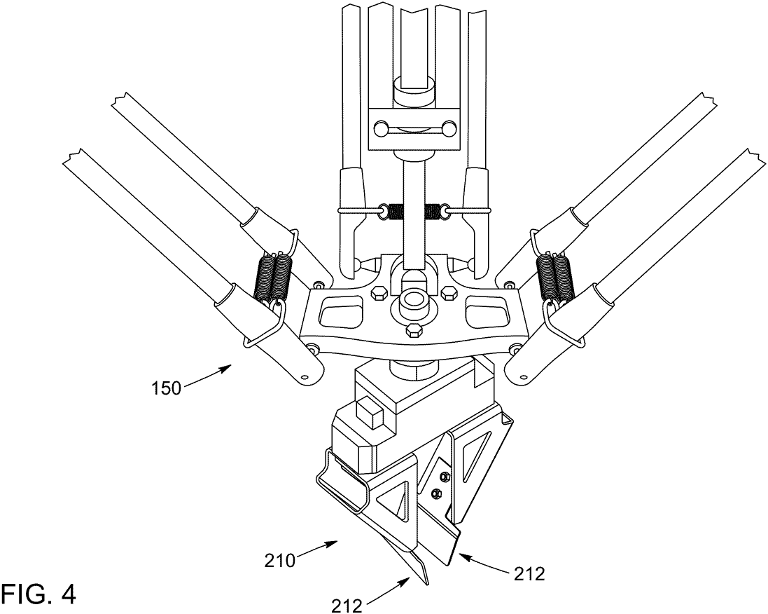

With reference to FIGS. 2 and 3, some components of the autonomous vehicle 10 are shown disassembled. The components shown include a frame, or chassis, 12 and a picking module 100 mounted thereon, including an agricultural implement 200 for picking weeds, for weeding the field. The picking module can be affixed underneath the vehicle or attached to one of its sides and tracked. The agricultural implement may also be configured and adapted for thinning the field, where in this case, selected immature crops are removed to provide enough room to allow stronger crops to grow. As such, the picking module can also be referred to a weeding and/or to a thinning module. In possible implementations, such as the one illustrated, the agricultural implement 200 can be a gripper 210. In the illustrated implementation, there is provided three grippers 210a, 210b, 210c, each capable of weed picking and removal in a predefined zone underneath the vehicle. Alternatively, there may be provided a single gripper for serving the entire zone, or multiple grippers serving overlapping zones. In one implementation, it is preferable that the grippers are configured to not only grab weeds from the above-ground portion of the weed (e.g., the leaves), but to pinch the roots of the weeds and fully retrieve them from the ground. Picking at the root of the weed or plant may reduce the likelihood of the weed regrowing, whether in place or displaced elsewhere. In the illustrated implementation, the grippers 210 are installed at an end of a delta robot 150, with the delta robot 150 providing translational and rotational movement, as will be explained in more detail. In a possible implementation, and with reference to the example illustrated in FIG. 4, the gripper may comprise two jaws or plates 212, which can be controlled such that they can be spaced apart or brought together to pinch the weeds or plants, such as the stems, preferably near or within the soil, close to the roots. As will be explained in more detail, the gripper can be moved along a plane parallel to the soil and rotated along a vertical axis.

The picking module 100 may comprise frame 102 onto which the grippers 210 and other parts can be mounted, as well as a processing module 400 comprising a processor 414 and non-transitory memory 412 for storing and carrying out computer instructions (see FIG. 10). The frame 102 can include structural members, such as tubes, and side plates to protect the components of the modules from dust, mud and/or water. The frame 102 may also include connecting members (not shown) adapted to connect to the frame 12 of the agricultural vehicle 10. In possible implementations, the weed picking module can be a distinct, independent module, mountable onto different types of agricultural vehicles, which may or not be autonomous vehicles. In other implementations, the weed picking module can be provided as part of and integral to the vehicle, such as in the illustrated implementation. The picking module may also be attached and tracked behind a tractor or other similar vehicle.

The picking module 100 additionally may include cameras 220 mounted thereon for identifying weeds, extra or immature plants and crops in the agricultural field. The cameras 220 may be coupled to lights mounted in proximity thereof for illuminating the field of vision of the cameras 220, providing improved images. In the illustrated implementation as shown in FIGS. 2 to 5, there is shown a weed picking module 100 with cameras 220 mounted onto the frame 102 of the weed picking module 100. Alternatively, the cameras 220 may be mounted proximate to the gripper 210, such as on the end of the delta robot 150. In one implementation, the cameras 220 may instead, or additionally, be mounted onto the vehicle 10. The lights coupled to the cameras 220 may also be mounted either onto the weed picking module 100, or the vehicle 10.

With the implementation shown, when the autonomous weeding vehicle 10 passes in an agricultural field, the picking module 100 is activated. Once the picking module 100 is activated, the cameras 220 begin capturing images of the field. In one implementation, the cameras 220 are coupled to a transceiver module for transmitting images to a remote site where an artificial intelligence (AI) system identifies weeds and crops. In one implementation, the images transmitted by the cameras 220 are interpreted by an operator at the remote site who marks crops and weeds, and also optionally immature crops that are to be removed for thinning. The cameras 220 may transmit the images through any wireless communication system to the remote site. In yet other implementations, the AI module and image analysis can be conducted locally, in a processing device provided on the vehicle and in communication with a controller controlling the weed picking implement.

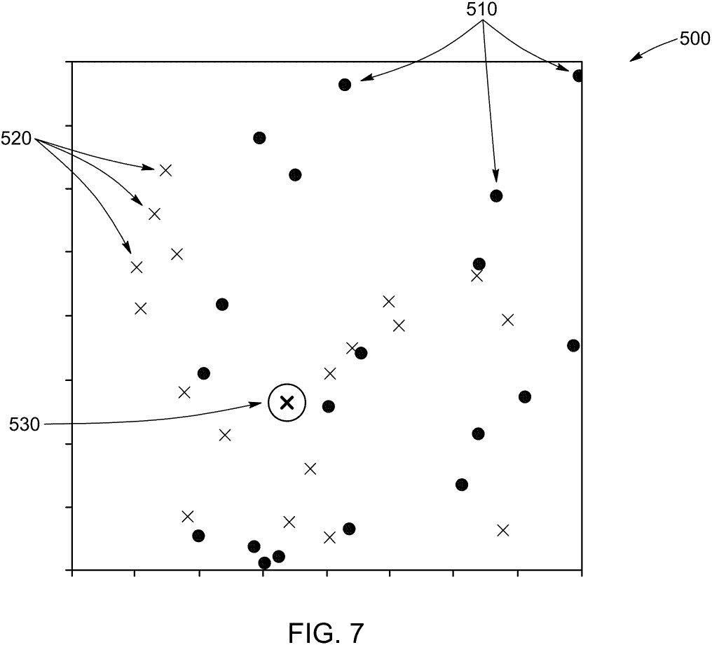

According to the images generated and marked with respect to weeds and crops, and possibly other plants, such as immature crops, a map 500 may be generated identifying the coordinates of weeds 520 and crops 510 in the area captured by the images (see FIG. 7). The weeds and crops appearing in the images captured by the image sensors or cameras can be first identified by pixel analysis. Their coordinates can then be determined. For example, a Euclidean map can be generated, using Simultaneous Localization and Mapping (SLAM) algorithms, which allows building a map and localizing the vehicle and/or picking modules at the same time. In a possible implementation, pixels of the map 500 can be classified as weed, crop or other, such as other types of plants or immature, week crops, and this classification can be used to determine a center coordinate of the plants, such as weeds and crops. In possible implementations, different types of weeds and plants could be detected, and the weed picking method could be adapted accordingly. In a possible implementation, machine learning models, such as deep neural network models, can be used to differentiate between weeds, immature crops and desired crops.

In one implementation, the map 500 may instead, or in addition to the cameras of the weeding module 100, be provided by another image capture system such as a satellite image. As the vehicle travels through the agricultural field, the map 500 may be continuously updated with images captured by the cameras. Additionally, a speed of the vehicle may be aligned with the camera capture rate and the processor. The speed of the vehicle may be calibrated so that the vehicle moves through the field at a rate that allows for the cameras and the processor to capture and process images, and to then effect weed picking by the gripper 210.

The processing module 400 is configured to receive inputs, such as the map 500 or the weed and crop coordinates, process the inputs, and output data for controlling the gripper. For example, the map 500 or map data may include coordinates of weeds 520 and crops 510. The coordinates can be provided or accessed through input ports 410 to the memory 412 and the processor 414, the processor 414 generating an offset for the gripper 210 to move and rotate to, based on the received coordinates, and sending the offset information via output ports 416 to a controller for controlling the gripper 210. The controller controls the movement of the grippers 210 based on the coordinates of the weeds and crops. In one implementation, the controller comprises a first actuator for controlling movement of the gripper and a second actuator for actuation of the jaws (opening and closing) of the gripper. In one implementation, the at least first actuator comprises four actuators, each one corresponding to translation along the x, y and z axes, as well as rotation around the z axis. In the illustrated implementation, the weed picking module 100 is installed underneath the autonomous weeding vehicle 10. In one implementation, the weed picking module 100 may be installed in a front, a side, or a rear portion of the vehicle 10 for carrying out weed picking. In the illustrated implementation, the grippers 210 of the weed picking module 100 are moveable via three mechanical arms which allow for translational motion of the grippers along three degrees of freedom, also known as a delta robot configuration. The grippers 210 are further rotatable along a vertical axis of the autonomous weeding vehicle 10. The grippers 210 thus have four degrees of freedom, three translational and one rotational. Alternatively, the grippers 210 may have fewer or greater degrees of freedom depending on design requirements, or they may use a movement configuration different to a delta robot configuration. For example, they may instead use a gantry system whereby the gripper is translatable along three axes. In preferred implementations, the gripper is translated along 3 degrees of freedom (DOF: x, y, z) and rotated about the z axis, allowing controlling the gripper with 4 DOF. While providing better results, rotation of the gripper 210 may be optional, and it can be considered only to translate the gripper 210 in accordance with the optimal location/offset that will maximize the number of weeds 530 that can be picked in a single take, while avoiding the crops 510. For thinning purpose, the offset can be calculated to maximize the number of immature crops to remove near the desired, stronger crops.

The processing module 400 is thus configured to maximize a weed picking rate by maximizing the number of weeds 520 to be picked in a single take. A single take, or picking event, involves deployment of the gripper 210 from a first position, such as proximate to the frame 102 of the picking module 100, to a second position proximate the ground for weed or immature crop picking. The map 500 produced based on the images is processed, and an anchor weed 530 is selected (see FIG. 7). When identified objects, such as weeds 530 and crops 510, in the map 500 coincide with the working area of the picking module, the weed 530 can be grabbed: at that point an optimization search is conducted to determine the next optimal picking location to maximize the number of weeds picked in a single take. The picking location can generally correspond to the center of the implement or gripper. It will be noted that the field of view of the camera 220 does not need to correspond to the working area of the agricultural implement or gripper 210. What is needed is that the coordinates of the weeds 520 be contained within the working area of the implement. It will be also noted that, since the vehicle 10 is in motion, the working area continuously changes as the vehicle 10 advances in the field, which is taken into account by the processing module 400.

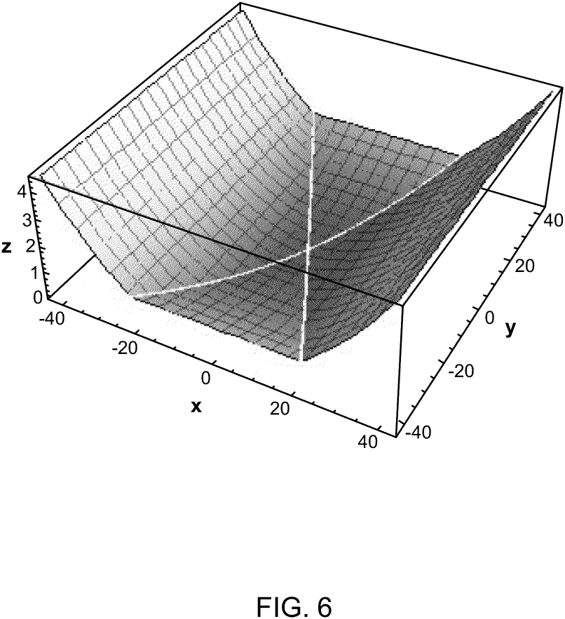

The anchor weed 530 corresponds to a weed that must be picked in a weed picking event. The anchor weed 530 may, in one implementation, be the closest weed to the gripper 210 (selection based on proximity to the gripper). In one implementation, the anchor weed 530 may instead be selected based on other parameters, such as the number of weeds 520 in a cluster of weeds, for example allowing for a maximum number of weeds 520 to be picked in a single take. The cluster of weeds defines a group of weeds 520 that are removeable in a single take and includes the anchor weed 530. In this implementation, the memory 412 of the processing module 400 may include instructions for the processor 414 to form multiple clusters of weeds, then resolve and compare solutions for each cluster to find which solution allows for the greatest number of weeds 520 to be picked in a single take. AI clustering models can be used to form the clusters of weeds, such as k-means models. Alternate clustering methods can also be used, such as simpler Euclidian distance-based methods. Since several clusters are likely to be formed, the system can choose the cluster which optimizes a “loss function”. Parameters inputted in the clustering loss function can include the number of weeds in a given cluster, the presence of a crop 510, the distance of the cluster from the crop 510 and whether the shape of the loss function is similar to the footprint of the gripper 210. The loss function can be optimized at least one of maximizing the number of weeds to be picked and avoiding the crops within a given space. The space can be a 3D space or zone, such as the one represented by FIG. 6.

The anchor weed 530 may also be selected based on constraints, for example being selected to avoid gripper 210 contact with the crop 510. In possible implementations, the processor 414 may find that an anchor weed 530 cannot be picked while respecting the constraints, such as crop 510 avoidance. The anchor weed 530 may therefore need to be changed to allow for a solution which respects the constraints. In one implementation, the constraints may comprise a maximum or minimum weed distance from a crop 510. A maximum weed distance from a crop 510 may be chosen to allow for weeds 520 that are determined to be too far to be competing with crops 510 to be left in the field. A minimum weed distance from a crop 510 may be chosen to reduce or eliminate the likelihood of contact of the crop 510 with the gripper. In one implementation, the constraints may comprise a maximum or minimum gripper distance from the crop 510. Similar to the weed distance previously mentioned, a maximum gripper distance may allow the gripper to ignore weeds too far away, while a minimum gripper distance may reduce or eliminate the likelihood of contact with the crop 510, to avoid damaging the crop while removing weeds. The minimum and maximum distances may be one of lateral distance, vertical distance, or a combination of the two to ensure that sufficient distance separates the gripper 210 from the crop 510.

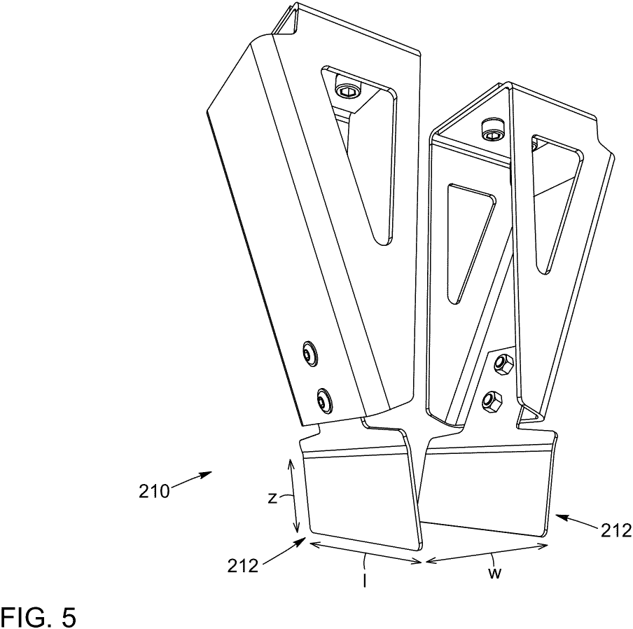

Picking the maximum number of weeds 520 per take involves, firstly, processing of the map 500 with respect to the anchor weed 530. The footprint of the gripper 210 may, in effect, be modelled. In a possible implementation, it can be modeled as a function in a 3D space, whereby the 3D space has an x-axis, a y-axis, and a z-axis. The distance between gripper jaws may be the width of the 3D space, the length of the jaws may be the length of the 3D space, while the grippable height, extending from a bottom end of the gripper jaw to a top end of the gripper jaw, may be the height of the 3D space. For example, and with additional reference to FIGS. 5 and 6, the gripper footprint may be modelled in the 3D space along an x and y plane using the following function:

$${p}_{x} = x - {x}_{c}$$

$${p}_{y} = y - {y}_{c}$$

$$z \left(x , y\right) = max \left({\left(\frac{{p}_{x}}{l}\right)}^{2} , {\left(\frac{{p}_{y}}{w}\right)}^{2}\right)$$

$$i f z \leq 1$$

Where z defines a point in the 3D space. l defines the length of the gripper/a jaw (i.e., the length of the 3D space), w defines the space between the jaws (i.e., width of the 3D space), x_{c} and y_{c} define center points of the gripper in the x and y plane, and x and y represent coordinates in the x and y plane. With reference to FIG. 6, z(x,y) has been plotted for illustrative purposes showing the footprint according to one embodiment using example values of 20 and 40 for l and w, respectively. The point z(x,y) is unitless, so long as both the numerator and the denominator use the same units. In the above example and as illustrated in FIG. 6, the point z(x,y) is within the gripper’s footprint if z(x,y) is equal to, or smaller than, 1. Alternatively, other values may be selected for z(x,y) based on specific values of gripper length and width. Additionally, in the above example l and w are constant values. However, w may instead be a variable value. This may be the case where the jaws are selectively operated to different widths between the jaws (e.g., fully open, or partially open).

In possible implementations, given that the gripper footprint can be further rotated around the z axis, the gripper footprint may fully be modelled using the following functions accounting for rotation along the z axis, in addition to positioning along the x and y planes:

$${p}_{x r} = cos \left(θ\right) {p}_{x} - sin \left(θ\right) {p}_{y}$$

$${p}_{y r} = sin \left(θ\right) {p}_{x} + cos \left(θ\right) {p}_{y}$$

$$z \left(x , y\right) = max \left({\left(\frac{{p}_{x r}}{l}\right)}^{2} , {\left(\frac{{p}_{y r}}{w}\right)}^{2}\right)$$

With the gripper footprint fully modelled, the first loss function (or cost function) which respects the constraints (e.g., crop avoidance) and the objectives of the weed picking device (e.g., maximum number of weeds per take), is then solved with respect to the picking space or zone defined above. As an example, the first loss function may be of the following form:

$$\text{argmax} \left(f \left(c , w\right)\right)$$

Where c is the number of crops and w is the number of weeds. For example, the crops 510 may each have a negative value (e.g., -3), while the weeds 520 may have a positive value (e.g., +1). The specific values may be selected by the operator. The function may be of the simplest form comprising the sum of c and w. The function may then be solved in the space and optimized. The processor optimizes for the value of the function with respect to the number of weeds 520 while respecting the constraints so that a maximum value is obtained. The optimized solution of the function, having the maximum value, represents a picking location where the maximum number of weeds 520 may be picked. In one implementation, even after applying a large penalty to a constraint, it is possible that the solution will still not respect a constraint. For example, it may be the case that five weeds 520 (with a value of +1 each) and one crop 510 (with a value of -3 each) are within the footprint of the gripper 210, having a sum of +2 which may suggest that the solution is optimal. Since this solution would also pick the one crop 510 along with the five weeds 520, it may not be acceptable. Accordingly, it may be desired to explicitly check a constraint to ensure that it is respected or to define the constraint with a very high value that cannot be overcome in any practical scenario.

In a next step, once the map 500 has been processed and the picking location selected in view of the optimized function, the positioning of the gripper 210 may be controlled accordingly. In a possible implementation, a second loss function may, therefore, additionally include optimization for positioning of the gripper:

$$\text{argmin} \left({f}_{{x}_{g} {y}_{g} {θ}_{g}} \left({P}_{w} , {P}_{c r} , {x}_{g} , {y}_{g} , {θ}_{g}\right)\right)$$

Where P_{w} is the xy coordinates of the weeds (including the anchor weed 530), P_{cr} is the xy coordinates of the crops, x_{g} is the offset of the x coordinate of the gripper, y_{g} is the offset of the y coordinate of the gripper, and θ_{g} is the offset of the orientation of the gripper. The function is optimized by looking for the minimal values of x_{c},y_{c} and θ with respect to the coordinates of the weeds 520 and the crops 510. That is, there is an offset that the gripper 210 must travel in the x and y directions and along the θ axis to arrive at the picking location which allows the gripper 210 to respect all the constraints, while maximizing the number of weeds 520 picked in a single take. The solution that results in the minimal value of the function is the optimized solution. The optimized solution comprises both an optimal offset, whereby the gripper moves by the offset amounts in the x and y directions and the θ axis, and an optimal weed picking location, where the greatest number of weeds may be picked in a single take. In one implementation, the optimal offset may instead be carried out in only one axis, only two axes or any other variation. Optimizing the second loss function allows centering the weeds to be picked relative to the center of the implement.

As an example, the second loss function ensures that that the gripper encompasses the coordinates of the anchor weed 530, at least one additional weed, while avoiding the crop 510. The processing module 400 may then control the gripper 210 to pick the weeds 520 in the optimal location, and then stores the information about the picked weeds 520 in the memory, so that the map 500 may be updated as the vehicle 10 moves through an agricultural field.

The second loss function may, in one implementation, be defined according to the following:

$${W}_{c o s t} = {\sum }_{p}^{{P}_{w}} z \left(p\right)$$

$${C}_{c o s t} = \frac{{\sum }_{p}^{{P}_{C}} z \left(p\right)}{{N}_{c r}}$$

Where:

$$i f {C}_{c o s t} \geq 1 , {T}_{c o s t} = {W}_{c o s t}$$

$$i f {C}_{c o s t} < 1 , {T}_{c o s t} = α ⋅ {W}_{c o s t}$$

Where W_{cost} is the cost with respect to the weeds, C_{cost} is the cost with respect to the crops, T_{cost} is the total cost, α is a number greater than 1, and N_{cr} is the number of crops considered by the gripper. N_{cr} has a minimum value of 1, since the gripper considers at least one crop when deciding which weeds to pick. In resolving the above functions, only those weeds and crops falling in the gripper footprint are considered (where z≤1). Any neighboring weeds and crops may be ignored. Per the above, where the cost for crops C_{cost} is equal to or greater than 1, there are no crops in the gripper footprint and the constraint of crop avoidance is respected. In this case, the total cost T_{cost} is equal to the cost for weeds W_{cost}. If C_{cost} is smaller than 1, however, the crop is inside the gripper footprint and would be grabbed. Accordingly, this would not respect the crop avoidance constraint and the solution would not be acceptable. In such a case, W_{cost} is multiplied by an arbitrarily large number α to return a large loss.

The optimized solution may be found through any number of optimization tools. In one implementation, optimization may be achieved through Particle Swarm Optimization (PSO). PSO optimizes a function by iteratively improving a potential solution with regards to given variables so as to obtain the best solution. Other optimization tools may equally be used, such as constrained optimization by linear approximation (COBYLA). In accordance with the above, the second loss function finds an optimal location for the gripper to maximize the number of weeds while respecting constraints in a first step. In a next step, the second loss function finds an optimal offset, using both translational and rotational motion, for the gripper to move along and arrive at the optimal location for picking the weeds. In one implementation, it may be desired to not optimise a solution. For example, the first loss function alone may be sufficient without consideration of the second loss function. In such a case, the only constraint to be considered may be, for example, whether there is a crop 510 inside the footprint of the gripper 210. The first loss function may accordingly be resolved while accounting only for crop avoidance. so that no optimisation is carried out for either maximizing the number of weeds or for finding an optimal offset to the optimal location. In one implementation, constraints may be shared between the optimal location and the optimal offset, for example to ensure that the gripper maintains a minimum distance to the crops as it moves in accordance with the optimal offset to an optimal location for weed picking.

The specific optimization tool, such as PSO or COBYLA, may be selected based on case-specific data or through comparison. In one implementation, for example, it was found that PSO resulted in a higher rate of weed picking, while also having a slightly higher rate of failure which was acceptable in the present case:

TABLE 1

| 1000 samples | fail rate | pick-able fails | average weed picked per pick | average time |
|---|---|---|---|---|
| PSO | 0.5% | 5 | 2.887 | 0.03469653968 s |
| COBYLA | 0.1% | 1 | 2.770 | 0.0374782737 s |
| 1000 samples (2) | | | | |
| P5O | 0.1% | 1 | 2.910 | 0.03183686363 s |
| COBYLA | 0.1% | 1 | 2.753 | 0.03927579847 s |
| 10000 samples | | | | |
| PSO | 0.70% | unknown | 2.9060 | 0.032279274302 s |
| COBYLA | 0.18% | unknown | 2.7572 | 0.03834485138 s |

Table 1 shows a comparison of two optimization tools, PSO and COBYLA, in one example based on 1,000 samples, a second example of 1,000 samples, and a third example of 10,000 samples, each sample corresponding to the number of times the algorithm was run based on given initialization conditions. The above is only provided for illustrative purposes. Other optimization tools may equally be preferred generally based on a compromise between accuracy and computational requirements.

In one implementation, the gripper 210 moves to the anchor weed 530 first, then determines the rotational and translational movement required to maximize the number of weeds in the take, while also grabbing the anchor weed 530. In one implementation, there may be other constraints/variables which the function can consider. For example, the function may additionally consider distance to the crop when determining an optimal offset or when determining the positioning of the gripper. In one implementation, the function may be capable of considering other factors, including time required to reach the weeds, where, for example, the minimum translation (implement travel distance) and rotation as defined in the second loss function do not result in a minimized or optimized gripper travel time.

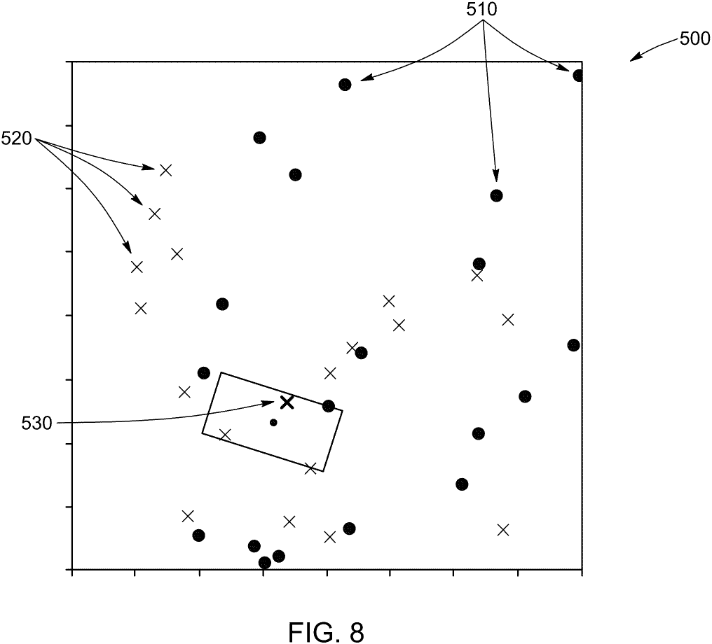

With reference to FIGS. 7 and 8, there is provided an example implementation of the above-described method. In FIG. 7, an exemplary field has been mapped following image capture and processing. In the map 500 are visible weeds 520 (x-shaped) and crops 510 (filled circles), as well as the anchor weed 530 (x-shaped surrounded by a circle). The second loss function can be used to determine the optimum solution, whereby the maximum number of weeds are picked in a single take while minimizing movement of the gripper. The positioning of the gripper is illustrated in FIG. 8, with the gripper footprint shown as a rectangle. The rectangle, or gripper footprint, represents the distance between the two jaws of the gripper and their length, such that any objects in that space can be grabbed by the gripper when the jaws close. The gripper is positioned to the optimal location and deployed so that it may pick the weeds in the gripper footprint. More specifically, the gripper is moved to the calculated position, which may correspond to the anchor weed coordinate plus an offset added to be able to grasp the additional neighbouring weeds. Moving the gripper may entail translating the picker along in x, y and z, and preferably also rotating the gripper. The gripper is then lowered, the jaws are opened (the order these steps can be inverted), the weeds are pinched, and the gripper is raised, and moved away from the crops, to dispose of the weeds. The memory then stores a parameter indicating that the weeds were picked, updates the map 500 to remove the picked weeds, and moves onto another position in the map 500 by choosing another anchor weed. This exercise is repeated until either no more weeds are left within the working area of the gripper, or that no more solutions exist which respect the constraints set by the operator. That is to say, if a weed cannot be picked while, for example, avoiding contact with a crop 510, due to proximity to the crop 510, then that weed may be left until either a constraint is softened or an operator sends overriding instructions.

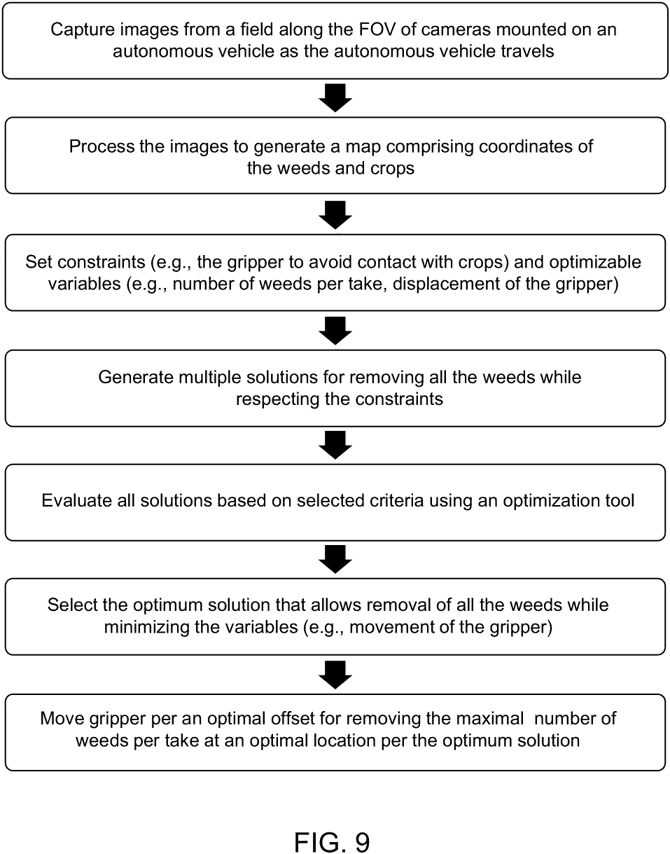

With reference to FIG. 9, there is provided an example flow chart based on the embodiment disclosed herein. In a first step, images are captured from a camera (or cameras), mounted onto the autonomous vehicle. In a second step, the processing module 400 of the autonomous vehicle then processes the images to generate a map 500 of the captured area which comprises coordinates of the weeds and crops. In a third step, constraints may be set including crop avoidance as well as the variables to optimize for in the second loss function, such as maximizing the number of weeds and minimizing gripper displacement. In a fourth to sixth step, an optimization tool is used to iteratively generate solutions and arrive at an optimum solution which respects the constraints previously set. Once the solution has been found for an optimal offset and a maximum number of weeds picked per take, the gripper is moved along the optimal offset and deployed at an optimal location whereby the maximum number of weeds are picked in a single take.

As disclosed, it is possible that a solution cannot be found for picking of a weed, even after softening constraints or changing the anchor weed. In such cases, an operator may decide to either ignore the weed or to override the constraints, for example allowing the gripper to make contact with a crop while picking the weed. Additionally, although we have treated the 3D space of the jaws as a constant space, it may additionally be modified. For example, the distance between the two jaws may be modified by moving the jaws closer together or further apart. This may be useful in cases where a solution cannot be found while respecting constraints with a larger space between the jaws, where a smaller distance allows a solution to be obtained.

Although reference and examples have been made to weed removal in accordance with one embodiment of the present disclosure, it is equally envisaged that other uses may be possible. For example, the agricultural implement may, instead of removing weeds from a field, remove extra or immature crops. Crop thinning is the process of removing young crops from a field to make space for other, stronger crops. For example, carrots are often planted in a row in a field. It is sometimes necessary to remove some carrots from the row to allow other carrots to grow to full size. It may also be necessary to remove carrots in areas where growth has been less than desired, due to poor sunlight or other factors. The removed carrots may then be replanted elsewhere or disposed of. Accordingly, instead of identifying and removing weeds from a field, the present disclosure may instead be directed to identifying and removing immature or selected crops, such as young carrots.

1. A method for picking weeds with an implement provided on an agricultural vehicle, the method comprising:
capturing images of a field traveled by the agricultural vehicle, the field comprising weeds and crops;
generating a map from the captured images, comprising coordinates of the weeds and crops;
determining, based on the coordinates of the weeds and crops, at least one picking location that maximizes a number of weeds to be picked in a single take and one offset for the implement to follow for arriving at the optimal location;
moving the implement along the offset; and
picking weeds at the optimal location with the implement.

2. The method of claim 1, wherein the implement avoids contact with the crops as it picks the weeds.

3. The method of claim 1, wherein moving the implement comprises a combination of rotational and translational movements.

4. The method of claim 1, wherein determining the offset comprises first selecting an anchor weed which has to be picked.

5. The method of claim 4, wherein the anchor weed is selected based on proximity to the implement.

6. The method of claim 4, wherein the anchor weed is selected based on the maximum number of weeds that may be picked in the single take while avoiding contact with the crops.

7. The method of claim 1, wherein avoiding contact with the crops comprises maintaining a minimum lateral distance between the implement and the crops.

8. The method of claim 4, wherein determining the offset comprises a step of forming clusters of weeds comprising the anchor weed.

9. The method of claim 1, wherein the picking location is determined using a first loss function which is optimized by at least one of maximizing the number of weeds to be picked and avoiding the crops within a given space.

10. The method of claim 9, wherein the offset is determined using a second loss function which is optimized to center the weeds to be picked relative to a center of the implement.

11. The method of claim 10, wherein:
inputs to the second loss function comprise the coordinates of the anchor weed, the respective coordinates of additional weeds, and the coordinates of any crops within a footprint of the implement;
determining the offset comprises optimizing the second loss function such that the footprint of the implement encompasses the coordinates of the anchor weed and at least one of the coordinates of the additional weeds while excluding the coordinates of any crops; and
output of the second loss function comprises the offset to apply to a current position of the implement and an identification of the weeds picked.

12. The method of claim 11, wherein the step of moving the implement along the offset comprises first applying the offset to a current position of the implement.

13. The method of claim 12, wherein the offset is further selected from a plurality of potential offsets based on at least one of time and implement travel distance required to pick all weeds at each picking location.

14. The method of claim 1, wherein the implement is a gripper comprising jaws and wherein the step of picking weeds comprises controlling the jaws of the gripper to pinch stems or roots of the weeds to pick them from the ground.

15. The method of claim 14, wherein the step of picking weeds comprises adjusting an opening width of the gripper based on the number of weeds to be picked.

16. The method of claim 1, wherein the images are captured using at least one camera on the agricultural vehicle.

17. A picking module provided on or attached to an agricultural vehicle, the module comprising:
an agricultural implement configured and adapted for weed picking, the implement being translatable along three degrees of freedom;
a controller configured to control the movement of the agricultural implement; and
a processing module comprising:
input ports for receiving coordinates of weeds and crops determined from images; and
a non-transitory memory and a processor, the non-transitory memory storing the coordinates and instructions for causing the processor to generate an optimal location for the implement that maximizes a number of weeds to be gripped in a single take; and
output ports for sending positioning data to the controller,
the controller moving the implement in accordance with the optimal location and positioning the implement over the weeds to be gripped based on the positioning data, and controlling operation of the implement to pick the weeds.

18. The weed picking module of claim 17, wherein the implement is also rotatable along at least one degree of freedom.

19. The weed picking module of claim 18, wherein the agricultural implement is a gripper comprising jaws configured and adapted to pinch and retrieve stems or roots of the weeds.

20. The weed picking module of claim 19, comprising one of a delta robot or a gantry system operatively connected to the agricultural implement, for translating the implement along the three axes.

21. The weed picking module of claim 17, wherein the controller comprises at least one first actuator for controlling movement of the gripper and a second actuator for actuation of the gripper.

22. The weed picking module of claim 17, wherein the memory comprises instructions to form clusters of weeds comprising an anchor weed.

23. The weed picking module of claim 17, wherein the memory stores a loss function which is configured to maximize at least one of:
number of weeds; and
distance of the implement to the crop.

24. The weed picking module of claim 23, wherein the instructions stored in memory cause the processor to:
input coordinates of the anchor weed, respective coordinates of additional weeds, coordinates of a crop, and a footprint of the implement to the loss function;
optimize the loss function such that the footprint of the implement encompasses the coordinates of the anchor weed and at least one of the coordinates of the additional weeds while excluding the coordinates of the crop; and
output, from the loss function, an offset to apply to a current position of the implement and an identification of the weeds picked.
